(19) United States
(12) Patent Application Publication
(10) Pub. No.: US 2024/0222981 A1
(43) Pub. Date: Jul. 4, 2024

(54) SYSTEM FOR THE CONVERSION AND GENERATION OF ENERGY THROUGH THE TRANSFORMATION OF A PHYSICAL-ELECTRICAL MEDIUM INTO AN ELECTRICAL MEDIUM

(71) Applicants: Fernando Javier LOPEZ STANIZZI, Estado de Morelos (MX); Gustavo Osvaldo MARTINEZ, Cordoba (AR)

(72) Inventor: Fernando Javier LOPEZ STANIZZI, Estado de Morelos (MX)

(73) Assignees: Fernando Javier LOPEZ STANIZZI, Estado de Morelos (MX); Gustavo Osvaldo MARTINEZ, Cordoba (AR)

(21) Appl. No.: 18/509,806

(22) Filed: Nov. 15, 2023

(30) Foreign Application Priority Data
Dec. 28, 2022 (AR) P20220103634

(51) Int. Cl. H02J 4/00; H02K 7/18

(52) U.S. Cl. CPC H02J 4/00; H02K 7/1823; H02J 2300/24; H02J 2300/28; H02J 2300/40

(57) ABSTRACT

A system for converting and generating electro-physical energy to electrical energy that can be accumulated and used as required. The system includes a high-density acrylic housing, a ring of magnetic suspension magnets, a number of coils, a control module, a dual accumulator module, a power output module, a mineral chamber, a solar panel and a turbine with variable magnetic blades.

### FIELD OF THE INVENTION

The invention consists of a system for the conversion and generation of energy by means of the transformation of a physical-electrical medium into an electrical medium.

The present system proposes a converter that, in the inventor's opinion, is the beginning of a revolutionary solution to the energy demand of the world and its future generations.

The components referred to in the description are exclusive of the invention, some may be variable and others are part of a parallel research that has been carried out to achieve the complete development of the system.

### BACKGROUND OF THE INVENTION

The energy problems that the world is facing are not new, and human beings have been searching for various alternative clean energy sources in order to preserve our world and provide efficient solutions according to our needs. Technologies are evolving and this generates increasing energy demands every day. It is also a reality that the increase in population has influenced the energy demand as there are more homes to supply every year.

Alternative energies such as solar or wind, are clean alternative sources, but their “Achilles heel” is power, especially solar where, to obtain a considerable amount of watts, we need large areas of solar panels that in stationary systems seem viable without major drawback that the provision of a land or surface suitable for installation, but for mobile systems such as vehicles, it is incompatible by the necessary volume of the collection panels.

As for wind energy, through the installation of huge generators to produce electricity by the action of the wind, it is proposed as an alternative source of clean energy, but also of bulky installation and incompatible with moving vehicles.

To overcome such difficulties, the present invention gathers all these sources into one, including an energy transformation through certain minerals which, being properly treated, form part of a multiple energy source, with the capacity to supply both fixed and mobile systems.

The present invention is coupled to a lithium and lithium polymer bank to store the generated energy and be able to deliver it at medium and high power as required automatically.

### SUMMARY OF THE INVENTION

The present invention consists of a system for converting and generating electro-physical energy to electrical energy that can be accumulated and used as required. The system includes a high-density acrylic housing, a ring of magnetic suspension magnets, a number of coils, a control module, a dual accumulator module, a power output module, a mineral chamber, a solar panel and a turbine with variable magnetic blades.

### BRIEF DESCRIPTION OF THE DRAWINGS

Simple sketches of the equipment and its main components are provided.

FIG. 1 shows a sketch where the different components and the interrelation between them are represented.

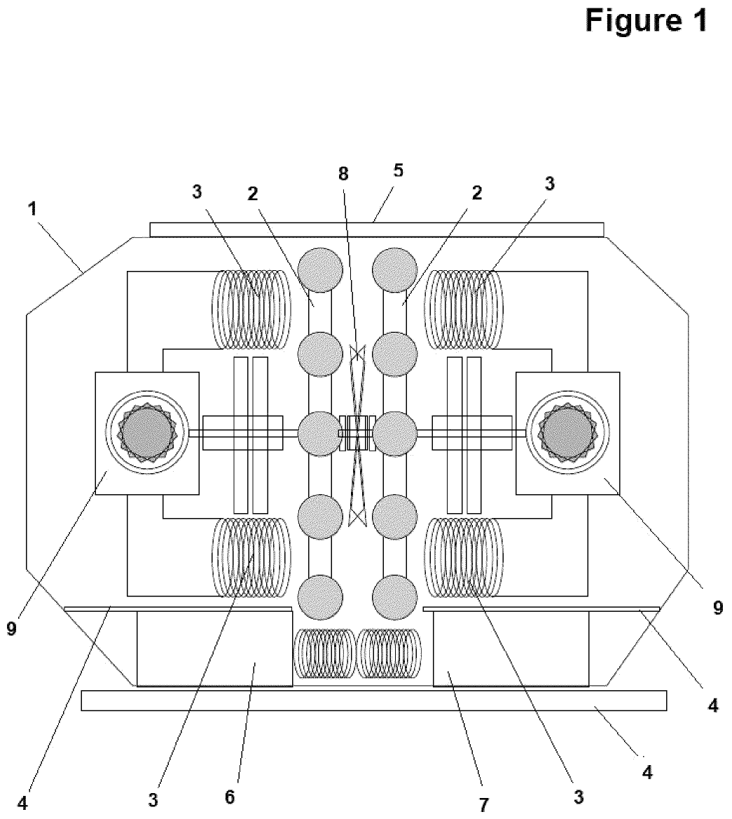

FIG. 2 shows a partial view of the lateral part of the converter.

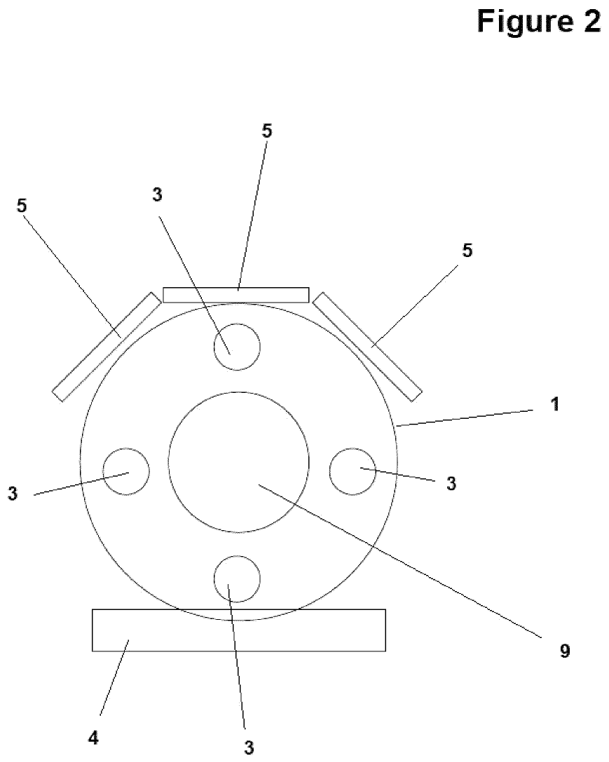

FIG. 3 shows a partial view of the control module and the mineral chamber.

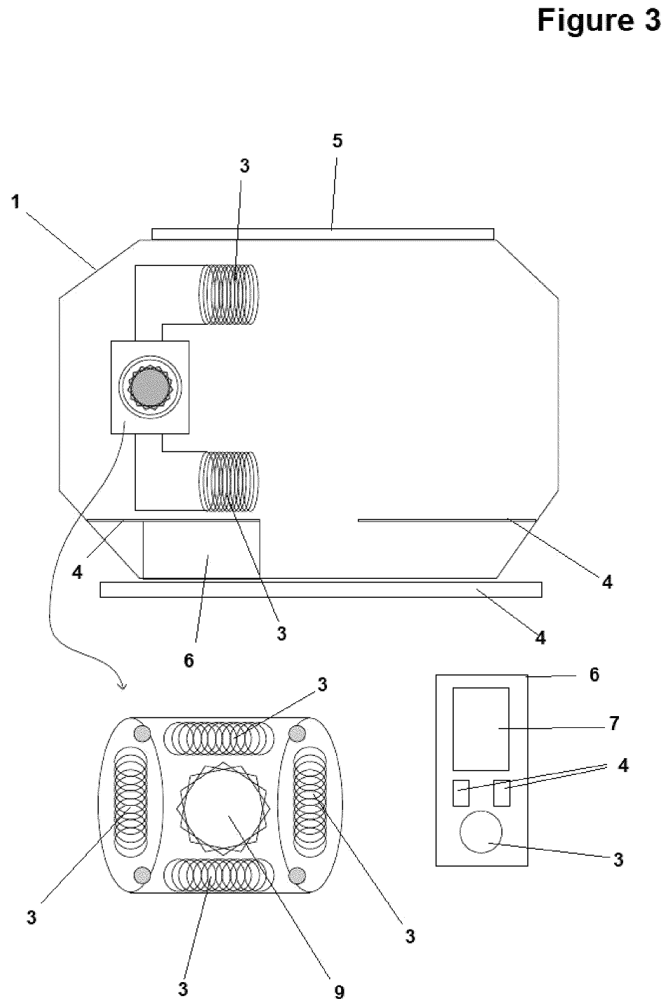

### DETAILED DESCRIPTION OF THE INVENTION

In the figures, references have been incorporated which allow individualizing the various parts and components of the system that complete the invention.

Reference number 1 a high-density acrylic housing, with reference number 2 a magnetized magnetic suspension ring, with reference number 3 a coil pack, with reference number 4 a fixing bracket, with reference number 5 a solar panel, with reference number 6 a control module, with reference number 7 a dual accumulator module, with reference number 8 a magnetic blade turbine, and with reference number 9 a mineral chamber.

### Operation

Once the components of the developed system have been described and in order to explain their nature, they are complemented with the description of their functional and operative relationship and the result they provide.

When the magnetic suspension ring is rotated, a cycle of electrical generation by induction begins, this induction activates an electromotive force in a group of coils which send the first part of the electricity that the system needs.

This pulsating electrical energy is channeled into the mineral chamber and then out of it in the form of constant electricity, causing a module to receive it and divert it to a special bank of accumulators.

The solar module provides additional extra energy to keep the system minimally stable when the sun is not present, this stability is maintained by a special turbine with magnetic blades attached to the main equipment.

The cycle is not infinite because the laws of thermodynamics prevent it, but the conversion, generation and accumulation occur with such high efficiency that the system has a very long useful life, with minimal maintenance required.

### Conclusion

This converter focuses on the use and exploitation of existing alternative energies, but with the particularity of making it portable, being able to replace large battery banks in electric cars and all electric vehicles that depend on volume and weight of batteries as it is nowadays.

The converter has many applications, due to the fact that its working principle can be assembled in a small system as well as in a huge system, providing the corresponding benefits in each case.

From the description made and the accompanying figures and references, and having explained the functional relationship of the component parts of the Energy conversion and generation system by means of the transformation of a physical-electrical medium into an electrical medium, the following is claimed as the exclusive right of this invention:

1. A system for converting and generating energy by transforming a physical-electrical medium into an electrical medium, the system comprising:
a high-density acrylic housing,
a solar panel,
a turbine with variable magnetic blades, and
a ring of magnets of magnetic suspension that rotating starts the electric generation cycle by induction that activates an electromotive force in a plurality of coils arranged for this purpose and that send a first part of the electricity that the system needs to a mineral chamber from where leaves in the form of constant electricity, to accumulate in a dual accumulator module, from where an output power module derives electricity to a bank of accumulators, all controlled by a control module;
wherein the system is a system for conversion and generation of electro-physical energies to electrical energies that are accumulated and used according to the needs of a site and users.

2. The system according to claim 1, where the solar panel provides additional extra energy for the system to remain stable when exposed to solar radiation.

3. The system according to claim 1, wherein the turbine with magnetic blades is in solidarity with the main equipment and maintains an electrical stability by the electrostatic energy coming from the air flow generated.

4. The system according to claim 1, wherein the conversion, generation, and accumulation occurs with such efficiency that the system has a very long useful life, with minimum maintenance.
